(19) United States
(12) Patent Application Publication
(10) Pub. No.: US 2023/0202586 A1
(43) Pub. Date: Jun. 29, 2023

(54) VEHICLE SPOILER

(71) Applicant: Honda Motor Co., Ltd., Tokyo (JP)

(72) Inventor: Naotaka MATSUI, Tokyo (JP)

(73) Assignee: Honda Motor Co., Ltd., Tokyo (JP)

(21) Appl. No.: 17/972,585

(22) Filed: Oct. 24, 2022

(30) Foreign Application Priority Data
Dec. 23, 2021 (CN) 202111608150.7

(51) Int. Cl. B62D 35/00

(52) U.S. Cl. CPC B62D 35/007

(57) ABSTRACT

The present disclosure provides a vehicle spoiler, which can stabilize the airflow passing through the vehicle, thereby improving the aerodynamic performance. The vehicle spoiler includes a plurality of skin portions arranged along the front-rear direction of the vehicle and overlapping each other in sequence in the front-rear direction of the vehicle; and a plurality of movable portions respectively supporting the plurality of skin portions and movable in the front-rear direction of the vehicle. The plurality of skin portions change the overall length in the front-rear direction of the vehicle through movement of at least one of the plurality of movable portions in the front-rear direction of the vehicle. Moreover, the plurality of skin portions are maintained to overlap in the movable range of the plurality of movable portions.

### CROSS-REFERENCE TO RELATED APPLICATION

This application claims the priority benefit of China application no. 202111608150.7, filed on Dec. 23, 2021. The entirety of the above-mentioned patent application is hereby incorporated by reference herein and made a part of this specification.

### BACKGROUND

### Technical Field

The present disclosure relates to a vehicle spoiler.

### Description of Related Art

In the related art, a spoiler is normally arranged at the rear end of the vehicle to improve the aerodynamic performance of the vehicle. A common spoiler may be a fixed spoiler with a specific shape. Currently there is also a spoiler (JP Laid Open No. H02-049681) that is set as a combination of a fixed portion and a movable portion, so the spoiler may be movable in the front-rear direction of the vehicle with respect to the fixed portion through the movable portion to change its position, thereby adjusting the aerodynamic performance. However, such a spoiler covers an inextensible skin portion above the fixed portion and the movable portion, so it is difficult for a single skin portion to change the overall length or the overall curvature along with the movement of the movable portion. Accordingly, there is limited improvement in aerodynamic performance of the overall spoiler.

### SUMMARY

The present disclosure provides a spoiler for a vehicle, which may stabilize the airflow passing through the vehicle, thereby improving the aerodynamic performance.

The present disclosure provides a vehicle spoiler, including: a plurality of skin portions arranged along the front-rear direction of the vehicle and overlapping each other in sequence in the front-rear direction of the vehicle; and a plurality of movable portions respectively supporting the plurality of skin portions and movable in the front-rear direction of the vehicle. The plurality of skin portions change the overall length in the front-rear direction of the vehicle through movement of at least one of the plurality of movable portions in the front-rear direction of the vehicle. Moreover, the plurality of skin portions are maintained to overlap in the movable range of the plurality of movable portions.

In an embodiment of the present disclosure, at least a part of the plurality of movable portions is connected through an elastic body, and the plurality of movable portions are driven by driving portions which are less in number than the plurality of movable portions.

In an embodiment of the present disclosure, each of the plurality of skin portions includes a main body portion and a plurality of connecting portions extending from the main body portion to the front and rear of the front-rear direction of the vehicle. Each of the plurality of skin portions is connected to the adjacent skin portion by making the plurality of connecting portions to pass through the lower sides of the main body portions included in the skin portions adjacent to each other in the front-rear direction of the vehicle.

Based on the above, in the vehicle spoiler of the present disclosure, the plurality of skin portions are arranged along the front-rear direction of vehicle, and are sequentially overlapped with each other in the front-rear direction of the vehicle. The plurality of skin portions change the overall length in the front-rear direction of the vehicle through movement of at least one of the plurality of movable portions in the front-rear direction of the vehicle. Moreover, the plurality of skin portions are maintained to overlap in the movable range of the plurality of movable portions. In this way, the plurality of skin portions may change the overall length or the overall curvature while maintaining the overlapping state with the movement of the movable portion. Accordingly, the vehicle spoiler of the present disclosure may stabilize the airflow passing through the vehicle, thereby improving aerodynamic performance.

In order to make the above-mentioned features and advantages of the present disclosure more comprehensible, the following embodiments are given and described in detail with the accompanying drawings as follows.

### BRIEF DESCRIPTION OF THE DRAWINGS

FIG. 1 is a schematic view of a vehicle spoiler applied to a vehicle according to an embodiment of the present disclosure.

FIG. 2 is a schematic view of the appearance of the vehicle spoiler shown in FIG. 1 viewed from above.

FIG. 3 is a schematic structural view of the vehicle spoiler shown in FIG. 1.

FIG. 4 is a schematic view of the operation of the vehicle spoiler shown in FIG. 3.

FIG. 5 is a schematic view of the appearance of a vehicle spoiler viewed from above according to another embodiment of the present disclosure.

FIG. 6 is a schematic structural view of the vehicle spoiler shown in FIG. 5.

FIG. 7 is a schematic plan view of one of the skin portions used in the vehicle spoiler shown in FIG. 5.

### DESCRIPTION OF THE EMBODIMENTS

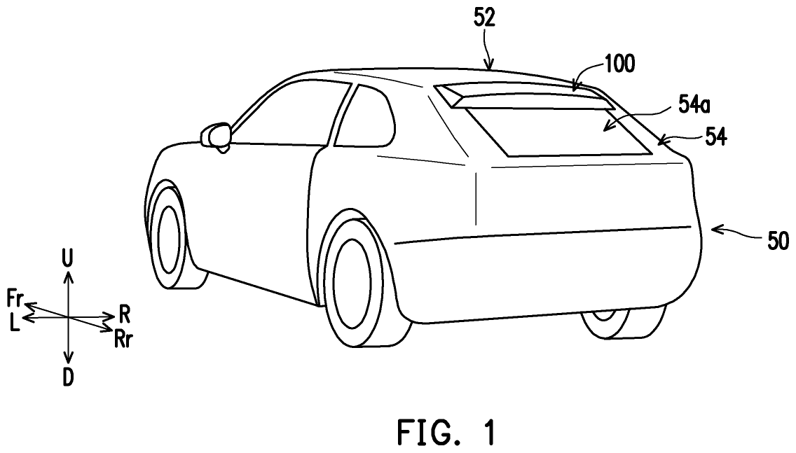

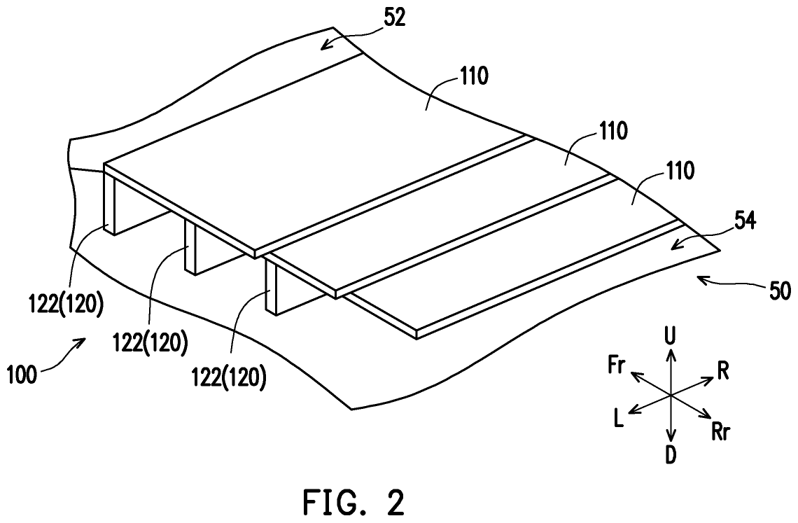

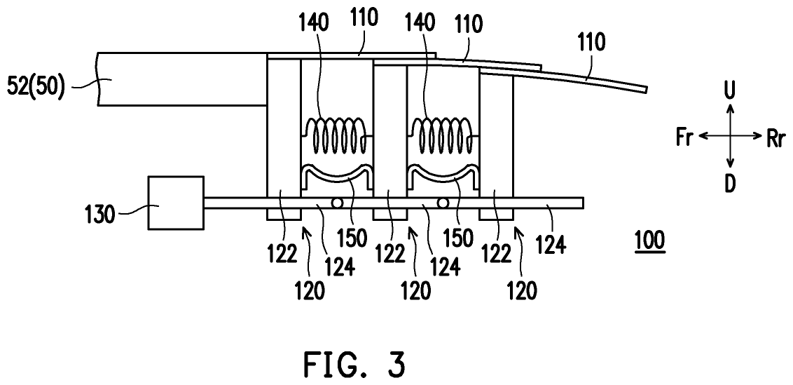

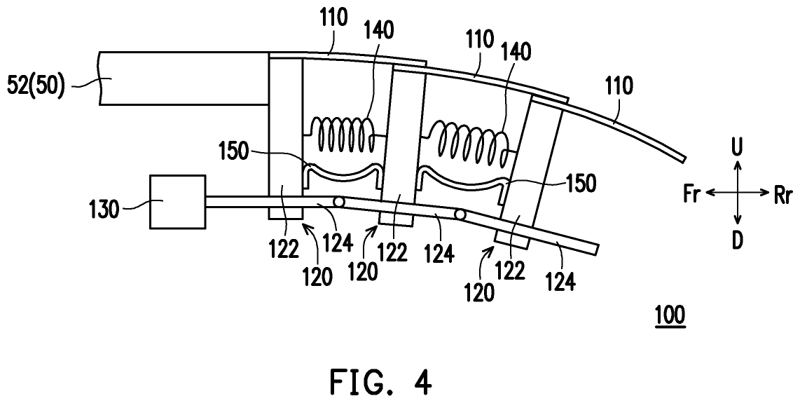

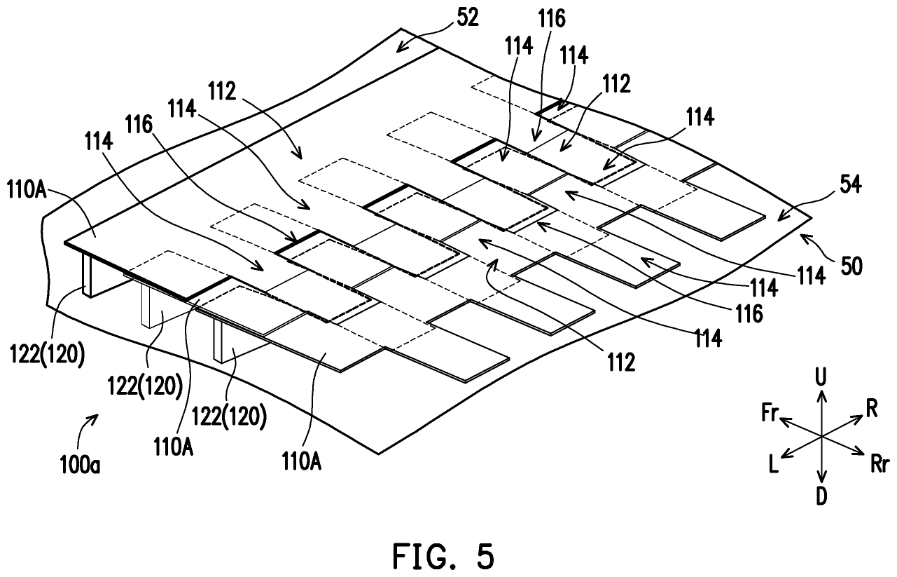

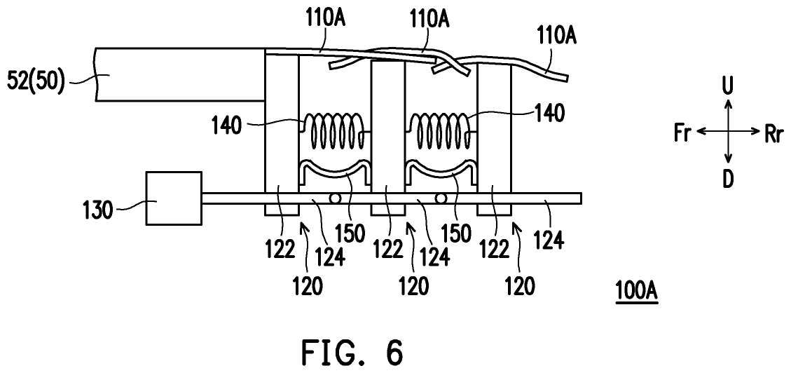

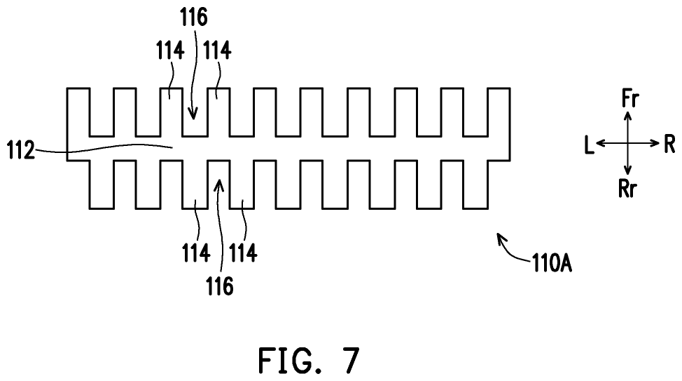

Reference will now be made in detail to the exemplary embodiments of the present disclosure, examples of which are illustrated in the accompanying drawings. FIG. 1 is a schematic view of a vehicle spoiler applied to a vehicle according to an embodiment of the present disclosure. FIG. 2 is a schematic view of the appearance of the vehicle spoiler shown in FIG. 1 viewed from above. FIG. 3 is a schematic structural view of the vehicle spoiler shown in FIG. 1. FIG. 4 is a schematic view of the operation of the vehicle spoiler shown in FIG. 3. FIG. 5 is a schematic view of the appearance of a vehicle spoiler viewed from above according to another embodiment of the present disclosure. FIG. 6 is a schematic structural view of the vehicle spoiler shown in FIG. 5. FIG. 7 is a schematic plan view of one of the skin portions used in the vehicle spoiler shown in FIG. 5. The application and specific structure of the vehicle spoiler 100 according to an embodiment of the present disclosure will be described below with reference to FIG. 1 to FIG. 4, and the vehicle spoiler 100A according to another embodiment of the present disclosure will also be described with reference to FIG. 5 to FIG. 7. However, the vehicle spoilers 100 and 100A are only partial examples of the present disclosure, and the present disclosure is not limited thereto.

Referring to FIG. 1, in the present embodiment, the vehicle spoiler 100 is adapted to be arranged at the rear end of the vehicle 50 (shown in FIG. 1) as an exterior component to stabilize the airflow passing through the vehicle 50, thereby improving aerodynamic performance. The vehicle spoiler 100 is, for example, a long and narrow structure spanning the left and right sides of the vehicle 50 (for example, the vehicle left direction L and the vehicle right direction R in FIG. 1), and is arranged at the rear of the roof 52 of the vehicle 50 and above the tailgate 54 of the vehicle 50, that is, provided at the junction of the roof 52 and the tailgate 54. However, in other embodiments that are not shown, the vehicle spoiler 100 may be arranged below the rear glass 54a used for the tailgate 54 of the vehicle 50, or may be arranged at other parts of the vehicle 50 according to requirements. The application of the vehicle spoiler 100 on the vehicle 50 is not limited in the disclosure, and may be adjusted according to requirements.

Specifically, in this embodiment, as shown in FIG. 2 and FIG. 3, the vehicle spoiler 100 includes a plurality of skin portions 110 and a plurality of movable portions 120. The plurality of skin portions 110 are arranged along the front-rear direction of the vehicle (e.g., the vehicle front direction Fr and the vehicle rear direction Rr in FIG. 1 to FIG. 3), and are sequentially overlapped with each other in the front-rear direction of the vehicle. The sequential overlapping with each other means that each skin portion 110 overlaps with another adjacent skin portion 110 in the front-rear direction of the vehicle, but not all skin portions 110 are overlapped together, but the disclosure is not limited thereto. Further, the plurality of movable portions 120 respectively support the plurality of skin portions 110 and are movable in the front-rear direction of the vehicle. For example, the plurality of movable portions 120 are connected to the driving portion 130 to be movable in the front-rear direction of the vehicle through the driving of the driving portion 130 (the details will be described later).

More specifically, as shown in FIG. 2 and FIG. 3, in this embodiment, each of the plurality of skin portions 110 is configured to span the left and right sides of the vehicle 50 (for example, the vehicle left direction L and the vehicle right direction R in FIG. 1 to FIG. 3). The front end of the first skin portion 110 is disposed outside the vehicle 50 (for example, provided at the rear of the roof 52 as described above) as viewed from the front to the rear in the front-rear direction of the vehicle (for example, the vehicle front direction Fr and the vehicle rear direction Rr in FIG. 1 to FIG. 3), and the rear end of the first skin portion 110 overlaps with the front end of the second skin portion 110, for example, the front end of the second skin portion 110 penetrates the lower side of the first skin portion 110. By analogy, the rear end of the second skin portion 110 overlaps with the front end of the third skin portion 110, for example, the front end of the third skin portion 110 penetrates the lower side of the second skin portion 110, and preferably the first skin portion 110 and the third skin portion 110 do not overlap in the front-rear direction of vehicle, but the disclosure is not limited thereto. Although the present embodiment only takes three skin portions 110 having the same structure as an example for description, in fact, the number, shape and size of the skin portions 110 may be adjusted according to requirements, and each skin portion 110 is not limited to having the same structure, the present disclosure is not limited thereto.

In addition, in the present embodiment, each of the plurality of movable portions 120 is configured as a plate frame 122 extending in the up-down direction of vehicle (for example, the vehicle upper direction U and the vehicle lower direction D in FIG. 3), as well as the rod 124 extending in the front-rear direction of the vehicle (for example, the vehicle front direction Fr and the vehicle rear direction Rr in FIG. 2) to connect to the plate frame 122. The plate frame 122 preferably spans the left and right sides of the vehicle 50 corresponding to the width of the skin portion 110 as shown in FIG. 2, but may also be set in a manner that the width of the plate frame 122 is smaller than that of the skin portion 110. The upper end of the plate frame 122 corresponds to the front end connected to the skin portion 110, and the lower end of the plate frame 122 is movably disposed on the rod 124, so that the plate frame 122 is movable relative to the rod 124 in the front-rear direction of vehicle, thereby driving the skin portion 110 to move in the front-rear direction of vehicle.

Furthermore, in this embodiment, as shown in FIG. 3, the plate frames 122 of the plurality of movable portions 120 are arranged side by side in the front-rear direction of the vehicle, and the rods 124 of the plurality of movable portions 120 are connected to each other in the front-rear direction of the vehicle, thereby extending along the front-rear direction of vehicle.

Preferably, the rods 124 are rotatably connected to each other, that is, the rod 124 may rotate relative to another rod 124 in the up-down direction of the vehicle with the vehicle width direction (for example, the direction perpendicular to the plan view in FIG. 3) as the axis, so that the plurality of skin portions 110 can change the inclination angle through the rotation of the plurality of movable portions 120 in the up-down direction of the vehicle. In this way, the plurality of skin portions 110 can not only change the overall length through the movement of the plate frame 122 in the movable portion 120 relative to the rod 124, but also can change the overall curvature through the relative rotation between the rods 124 in the movable portion 120.

In detail, please refer to FIG. 3 and FIG. 4, in this embodiment, the front end of each skin portion 110 connected to the corresponding plate frame 122 may be regarded as the root of the skin portion 110, and the rear end of the skin portion 110 may be regarded as the protruding end of the skin portion 110. Viewed from the front to the back in the front-rear direction of vehicle (for example, the vehicle front direction Fr and the vehicle rear direction Rr in FIG. 3), when the third movable portion 120 drives the third skin portion 110 to move backward, the plate frame 122 in the third movable portion 120 moves backward relative to the rod 124, such that the front end of the third skin portion 110 moves backward relative to the rear end of the second skin portion 110, so that the overlapping portion of the third skin portion 110 and the second skin portion 110 is reduced. Therefore, the exposed region between the rear end, that is, the protruding end, of the third skin portion 110, and the rear end, that is, the protruding end, of the second skin portion 110 is increased. Accordingly, even if only one skin portion 110 (e.g., the third skin portion 110) moves in the front-rear direction of vehicle through the corresponding movable portion 120 (e.g., the third movable portion 120), the overall length from the front end of the first skin portion 110 to the rear end of the last skin portion 110 (i.e., the third skin portion 110) also becomes longer.

Furthermore, in the present embodiment, when the overall length to be increased is longer, the plurality of movable portions 120 may be further moved in the front-rear direction of vehicle. By analogy, when the second movable portion 120 drives the second skin portion 110 to move backward, the plate frame 122 in the second movable portion 120 moves backward relative to the rod 124, so that the front end of the second skin portion 110 moves backward with respect to the rear end of the first skin portion 110. As such, the overlapping portion of the second skin portion 110 and the first skin portion 110 is reduced. Therefore, the exposed region between the rear end, that is, the protruding end, of the second skin portion 110 and the rear end, that is, the protruding end, of the first skin portion 110 increases. Of course, the movable portion 120 may also move forward in the front-rear direction of vehicle to increase the overlapping portion of the plurality of skin portions 110, thereby shortening the overall length of the plurality of skin portions 110, which is not limited in the present disclosure. Accordingly, the vehicle spoiler 100 may control at least one of the movable portions 120 to move in the front-rear direction of vehicle according to requirements, and the plurality of skin portions 110 may move in the front-rear direction of vehicle through at least one of the plurality of movable portions 120 to change the overall length.

In addition, in the present embodiment, since the purpose of the vehicle spoiler 100 is to stabilize the airflow passing through the vehicle 50 (shown in FIG. 1), it is preferable to form the vehicle spoiler 100 in a manner that there is no gap between the plurality of skin portions 110 on the exterior surface, that is, the plurality of skin portions 110 are sequentially overlapped in the front-rear direction of vehicle. Therefore, during the process in which the plurality of skin portions 110 move in the front-rear direction of vehicle through the plurality of movable portions 120, the plurality of skin portions 110 maintain overlapped in the movable ranges of the plurality of movable portions 120. That is to say, when the overall length to be adjusted is long, it is preferable that the plurality of movable portions 120 drive the plurality of skin portions 110 to move backward, rather than the single movable portion 120 drives the skin portion 110 to move away from the overlapping range of the adjacent skin portion 110. Accordingly, even if the overall length of the plurality of skin portions 110 is adjusted according to needs, the original function of the vehicle spoiler 100 is not degraded. Furthermore, the present disclosure does not exclude that the first skin portion 110 also moves through the first movable portion 120, as long as there is a component for shielding gaps provided between the exterior of the vehicle 50 (e.g., provided at the rear of the roof 52 as described above) and the front end of the first skin portion 110.

In addition, please refer to FIG. 3 and FIG. 4, in this embodiment, when viewed from the front to the back in the front-rear direction of vehicle (for example, the vehicle front direction Fr and the vehicle rear direction Rr in FIG. 3), when the third rod 124 rotates downward with respect to the second rod 124 in the up-down direction of vehicle with the vehicle width direction (for example, the direction perpendicular to the plan view in FIG. 3) as the axis, the third plate frame 122 rotates downward along with the third rod 124, so that the third skin portion 110 is also rotated downward. In this way, the vertical distance between the front end and the rear end of the third skin portion 110 rotated downward is increased, and thus the inclination angle of the third skin portion 110 is changed.

In addition, since the rear end of the second skin portion 110 is located at the front end of the third skin portion 110 and the upper end of the third plate frame 122, when the third plate frame 122 rotates downward along with the third rod 124, the rear end of the second skin portion 110 moves downward along with the upper end of the third plate frame 122 due to gravity. Thereby, even if the second plate frame 122 is not rotated downward, the vertical distance between the front end and the rear end of the second skin portion 110 is also increased. Accordingly, even if only one skin portion 110 (e.g., the third skin portion 110) is rotated in the up-down direction of the vehicle through the corresponding movable portion 120 (e.g., the third movable portion 120) to change the inclination angle, the overall curvature from the front end of the first skin portion 110 to the rear end of the last skin portion 110 (i.e., the third skin portion 110) also increases.

Furthermore, in the present embodiment, when the overall curvature to be increased is larger, the plurality of movable portions 120 may be further rotated downward in the up-down direction of vehicle. By analogy, when the second rod 124 rotates downward relative to the first rod 124 in the up-down direction of the vehicle with the vehicle width direction as the axis, the second plate frame 122 rotates downward along with the second rod 124, so that the second skin portion 110 is also rotated downward. In this way, the vertical distance between the front end and the rear end of the second skin portion 110 rotated downward increases, and thus the inclination angle of the second skin portion 110 changes. In addition, the rear end of the first skin portion 110 moves downward along with the upper end of the second plate frame 122 due to gravity, so that the vertical distance between the front end and the rear end of the first skin portion 110 also increases. Of course, the movable portion 120 may also be rotated upward in the up-down direction of the vehicle, thereby reducing the overall curvature of the plurality of skin portions 110, which is not limited in the present disclosure. Therefore, the vehicle spoiler 100 may control at least one of the movable portions 120 to rotate in the up-down direction of the vehicle as required, and the plurality of skin portions 110 may rotate in the up-down direction of the vehicle through at least one of the plurality of movable portions 120 to change the overall curvature.

In addition, in the present embodiment, the means for moving the plurality of movable portions 120 in the front-rear direction of the vehicle is listed as the movement of the plate frame 122 relative to the rod 124, and the means for rotating the plurality of movable portions 120 in the up-down direction of vehicle is listed as the rods 124 rotating relative to each other to drive the plate frame 122 to rotate in the up-down direction of vehicle. However, in other embodiments that are not shown, a single rod extending in the front-rear direction of vehicle may be adopted, the plate frames 122 each drive the corresponding skin portion 110 to move along the single rod in the front-rear direction of the vehicle to adjust the overall lengths of the plurality of skin portions 110. Moreover, the plate frames 122 may be additionally provided with rotating mechanism to realize the rotation of the plate frames 122 in the up-down direction of the vehicle. Alternatively, a movable mechanism other than the combination of the plate frame 122 and the rod 124 may be used as the movable portion 120. The present disclosure does not limit the specific implementation of the movable portions 120, which may be adjusted according to requirements.

Furthermore, in the present embodiment, as shown in FIG. 3 and FIG. 4, the vehicle spoiler 100 further includes a driving portion 130. The driving portion 130 is, for example, an electric motor (but not limited thereto), to drive the plurality of plate frames 122 to move in the front-rear direction of the vehicle, or to drive the rods 124 to rotate relative to each other. Accordingly, the movable portion 120 is configured to be movable in the front-rear direction of vehicle through the driving of the driving portion 130. The plurality of movable portions 120 are connected through the elastic body 140, and the plurality of movable portions 120 are driven by the driving portions 130 which are less in number than the plurality of movable portions 120.

In detail, in this embodiment, as shown in FIG. 3, elastic bodies 140 (e.g., springs) are provided between the plate frames 122 of the plurality of movable portions 120, for example, two elastic bodies 140 are provided between the three plate frames 122. In addition, one driving portion 130 is provided in the vicinity of the first movable portion 120. The driving portion 130 is electrically connected to the plate frame 122 of the first movable portion 120, so that the plate frame 122 of the first movable portion 120 may be driven to move backward relative to the rod 124 in the front-rear direction of the vehicle. Under the circumstances, the plate frame 122 of the first movable portion 120 that moves backward exerts a pushing force on the elastic body 140 connected to the rear of the plate frame 122. The pushed elastic body 140 accumulates elastic force and releases the elastic force, thereby pushing the connected frame plate 122 of the second movable portion 120 to move backward.

By analogy, the plate frame 122 of the second movable portion 120 that moves backward exerts a pushing force on the elastic body 140 connected to the rear of the plate frame 122. The pushed elastic body 140 accumulates elastic force and releases the elastic force, thereby pushing the connected frame plate 122 of the third movable portion 120 to move backward.

Correspondingly, when the driving portion 130 drives the plate frame 122 of the first movable portion 120 to move forward relative to the rod 124 in the front-rear direction of vehicle, the plate frame 122 of the first movable portion 120 that moves forward exerts a pulling force on the elastic body 140 connected to the rear of the plate frame 122. The pulled elastic body 140 pulls the connected plate frame 122 of the second movable portion 120 to move forward. Subsequently, the plate frame 122 of the second movable portion 120 that moves forward exerts a pulling force on the elastic body 140 connected to the rear of the plate frame 122. The pulled elastic body 140 pulls the connected plate frame 122 of the third movable portion 120 to move forward. In this way, in this embodiment, as shown in FIG. 3, when three movable portions 120 are matched with two elastic bodies 140, the three movable portions 120 may be driven by providing only one driving portion 130. In this way, the plurality of movable portions 120 are driven by driving portions 130 that are less in number than the plurality of movable portions 120, thereby reducing the cost.

In other embodiments that are not shown, an elastic body 140 may be provided between the second movable portion 120 and the third movable portion 120, and two driving portions 130 are additionally provided to be electrically connected to the first movable portion 120 and the second movable portion 120 respectively, so that the operation of the first movable portion 120 is driven separately from the operation of the second movable portion 120, and the operation of the third movable portion 120 is linked with the second movable portion 120 through the elastic body 140. Alternatively, the elastic body 140 may not be provided, and each movable portion 120 is driven by a corresponding driving portion 130. Therefore, the moving range of each movable portion 120 in the front-rear direction of the vehicle may be adjusted to be the same or different according to requirements, which allows the adjustment of the overall length of the plurality of skin portions 110 to be more diverse. Furthermore, in the case where the rods 124 of the plurality of movable portions 120 can rotate relative to each other, preferably the driving portion 130 may also be electrically connected to the rods 124 to drive the rods 124 to rotate relative to each other. The present disclosure does not limit the type and quantity of the driving portion 130, and does not limit the type, quantity, and arrangement of the elastic bodies 140.

In addition, in this embodiment, a shield 150 located under the skin portion 110 is preferably disposed between every two adjacent movable portions 120. The shield 150 is, for example, a rubber pad, which is connected between the plate frames 122 of every two adjacent movable portions 120. In the case where the elastic body 140 is provided between every two adjacent movable portions 120, the shield 150 is further disposed below the elastic body 140. Accordingly, it is possible to prevent the airflow passing through the vehicle 50 (shown in FIG. 1) from passing through the vehicle spoiler 100 from below to above, thereby suppressing the occurrence of turbulent flow below the plurality of skin portions 110. However, the present disclosure does not limit the type, quantity, and arrangement of the shield 150, which may be adjusted according to requirements.

It may be seen from the above that in the present embodiment, the vehicle spoiler 100 is provided with a plurality of skin portions 110. When the movable portion 120 moves relative to the fixed portion of the vehicle 50 (such as the fixed frame arranged on the outside of the vehicle 50) in the front-rear direction of the vehicle, the plurality of skin portions 110 may move along with the operation of the plurality of movable portions 120. Therefore, compared with the related art using a single skin portion that cannot be stretched, the plurality of skin portions 110 may change the overall length or the overall curvature while maintaining the overlapping state with the movement of the movable portion 120. The more skin portions 110 (for example, 20 or more) are used within the required length, the smoother the curved surface formed by the plurality of skin portions 110 is, and the movement of the plurality of skin portions 110 moving along with the plurality of movable portions 120 is smoother, so that the adjustment method of the vehicle spoiler 100 is more diverse. Accordingly, the vehicle spoiler 100 may stabilize the airflow passing through the vehicle, thereby improving the aerodynamic performance.

Next, please refer to FIG. 5 and FIG. 6, in this embodiment, the vehicle spoiler 100A includes a plurality of skin portions 110A and a plurality of movable portions 120, and a driving portion 130, an elastic body 140, and a shield 150 and other components may be further used. That is, the vehicle spoiler 100A has a similar structure to the aforementioned vehicle spoiler 100, and the main difference is that the shapes of the plurality of skin portions 110A used in the vehicle spoiler 100A are different from the shapes of the plurality of skin portions 110 used in the spoiler device 100. Therefore, the overlapping manner of the skin portions 110A is different from the aforementioned overlapping manner of the skin portions 110. The differences between the vehicle spoiler 100A and the vehicle spoiler 100 will be described below. For the implementation of other parts, reference may be made to the aforementioned vehicle spoiler 100, which will not be repeated here.

In this embodiment, as shown in FIG. 5 to FIG. 7, each of the plurality of skin portions 110A has a main body portion 112 and a plurality of connecting portions 114 extending from the main body portion 112 to the front and rear in front-rear direction the vehicle (for example, the vehicle front direction Fr and the vehicle rear direction Rr in FIG. 5 to FIG. 7). The main body portion 112 has a plate-like structure spanning the left and right sides of the vehicle 50 (for example, the vehicle left direction L and the vehicle right direction R in FIG. 7), and the plurality of connecting portions 114 extend from the main body portion 112 to the front and rear, and thus constitutes a fence-shaped structure. In addition, the connecting portion 114 extending forward from the main body portion 112 and the connecting portion 114 extending backward from the main body portion 112 are staggered in the front-rear direction of vehicle. The recess 116 between two adjacent connecting portions 114 extending forward corresponds to one connecting portion 114 extending backward, and the recess 116 between two adjacent connecting portions 114 extending backward corresponds to one connecting portion 114 extending forward.

Thus, in the present embodiment, the plurality of skin portions 110A are arranged along the front-rear direction of vehicle (for example, the vehicle front direction Fr and the vehicle rear direction Rr in FIG. 5 to FIG. 7), and are overlapped with each other in sequence in the front-rear direction of vehicle. Overlapping with each other in sequence means that each skin portion 110A overlaps with another adjacent skin portion 110A in the front-rear direction of vehicle. Each of the plurality of skin portions 110A is connected to the adjacent skin portion 100A by making the plurality of connecting portions 114 to pass through the lower sides of the main body portions 112 included in the skin portions 110A adjacent to each other in the front-rear direction of the vehicle.

In detail, in this embodiment, when viewed from the front to the back in the front-rear direction of vehicle (e.g., the vehicle front direction Fr and the vehicle rear direction Rr in FIG. 5), the front end of the first skin portion 110A is not provided with the connecting portion 114 extending forward. Instead, the front end of the main body portion 112 is provided outside the vehicle 50 (for example, provided at the rear of the roof 52 as described above). However, in other embodiments that are not shown, the front end of the first skin portion 110A may also be provided with a connecting portion 114 extending forward, as long as there is a component for shielding gaps provided between the exterior of the vehicle 50 and the front end of the first skin portion 110, and the present disclosure is not limited thereto. Furthermore, the connecting portion 114 of the first skin portion 110A extending backward passes through the lower side of the main body portion 112 included in the second skin portion 110A from the front to the back. In this way, the rear end of the first skin portion 110A overlaps with the front end of the second skin portion 110A, and the first skin portion 110A is connected to the adjacent second skin portion 110A.

By analogy, the connecting portion 114 of the second skin portion 110A extending forward passes through the lower side of the main body portion 112 included in the first skin portion 110A from the back to the front. The connecting portion 114 of the second skin portion 110A extending backward passes through the lower side of the main body portion 112 included in the third skin portion 110A from the front to the back. The connecting portion 114 of the third skin portion 110A extending forward passes through the lower side of the main body portion 112 included in the second skin portion 110A from the back to the front. In this manner, the front end of the second skin portion 110A overlaps with the rear end of the first skin portion 110A, the rear end of the second skin portion 110A overlaps with the front end of the third skin portion 110A, and the second skin portion 110A is connected to the adjacent first skin portion 110A and the third skin portion 110A. The front end of the third skin portion 110A overlaps with the rear end of the second skin portion 110A, and the third skin portion 110A is connected to the adjacent second skin portion 110A.

Furthermore, in this embodiment, since the connecting portion 114 extending forward and the connecting portion 114 extending rearward included in the skin portion 110A are staggered in the front-rear direction of vehicle, the connecting portion 114 of the first skin portion 110A extending backward passes through the recess 116 between the connecting portions 114 extending forward of the second skin portion 110A from the front to the back, and the connecting portion 114 of the second skin portion 110A extending forward passes through the recess 116 between the connecting portions 114 of the first skin portion 110A extending backward from the back to the front. By analogy, the connecting portion 114 of the second skin portion 110A extending backward passes through the recess 116 between the connecting portions 114 of the third skin portion 110A extending forward front the front to the back. The connecting portion 114 of the third skin portion 110A extending forward passes through the recess 116 between the connecting portions 114 of the second skin portion 110A extending backward from the rear to the front. In this way, the connecting portion 114 of each skin portion 110A extending forward corresponds to each other in the front-rear direction of vehicle, and the connecting portion 114 of each skin portion 110A extending backward corresponds to each other in the front-rear direction of vehicle. Although this embodiment only takes three skin portions 110A having the same structure as an example for description, the number, shape and size of the skin portions 110A may be adjusted according to requirements, and each skin portion 110A is not limited to having the same structure. The present disclosure is not limited thereto.

Therefore, in the present embodiment, the plurality of skin portions 110A in the vehicle spoiler 100A may also adjust its overall length in the front-rear direction of vehicle, or further adjust its overall curvature through the movement of the plurality of movable portions 120 like the aforementioned plurality of skin portions 110, and the plurality of skin portions 110A are maintained to overlap in the movable range of the plurality of movable portions 120. The vehicle spoiler 100A may be applied to the vehicle 50 shown in FIG. 1 like the aforementioned vehicle spoiler 100 to stabilize the airflow passing through the vehicle 50, thereby improving aerodynamic performance. That is to say, the specific structure of the vehicle spoiler 100A may be obtained by appropriately replacing the skin portion 110 described in the aforementioned vehicle spoiler device 100 with the skin portion 110A described later, but the present disclosure is not limited thereto. Other parts of the vehicle spoiler 100A may be adjusted according to requirements.

In addition, in the present embodiment, since the connecting portion 114 of each skin portion 110A passes through the lower side of the main body portion 112 included in the adjacent skin portion 110A through the recess 116 in the adjacent skin portion 110A, the movement of the plurality of skin portions 110A in the front-rear direction of vehicle do not interfere with each other. In addition, compared to the state where the rear end of the skin portion 110 is a free end, the rear end of the skin portion 110A and the adjacent skin portion 110A in this embodiment not only overlap but are also connected to each other, so the rear end of the skin portion 110A is not easily flipped open by the airflow passing through the vehicle 50 (shown in FIG. 1). That is, gaps are less likely to be generated between the plurality of skin portions 110A. However, the present disclosure does not limit the shapes of the plurality of skin portions 110A, which may be adjusted according to requirements.

To sum up, in the vehicle spoiler of the present disclosure, the plurality of skin portions are arranged along the front-rear direction of vehicle, and sequentially overlap each other in the front-rear direction of vehicle. The plurality of skin portions change the overall length in the front-rear direction of the vehicle through the movement of at least one of the movable portions in the front-rear direction of the vehicle, and the plurality of skin portions maintain overlap in the movable ranges of the plurality of movable portions. Preferably, a plurality of skin portions may be provided with a fence-shaped structure each having a main body portion and a plurality of connecting portions, and connected to the adjacent skin portion by making the plurality of connecting portions to pass through the lower sides of the main body portions included in the skin portions adjacent to each other. In this way, the plurality of skin portions may change the overall length or the overall curvature while maintaining the overlapping state along with the movement of the movable portion. Accordingly, the vehicle spoiler of the present disclosure may stabilize the airflow passing through the vehicle, thereby improving aerodynamic performance.

Finally, it should be noted that: the above embodiments are only used to illustrate the technical solutions of the present disclosure, but not to limit them; although the present disclosure has been described in detail with reference to the foregoing embodiments, those of ordinary skill in the art should understand: modifications may still be made to the technical solutions described in the foregoing embodiments, or some or all of the technical features thereof are equivalently replaced; and these modifications or replacements do not make the essence of the corresponding technical solutions depart from the scope of the technical solutions of the embodiments of the present disclosure.

What is claimed is:

1. A vehicle spoiler, comprising:
a plurality of skin portions arranged along a front-rear direction of a vehicle and overlapping each other in sequence in the front-rear direction of the vehicle; and
a plurality of movable portions respectively supporting the plurality of skin portions and movable in the front-rear direction of the vehicle,
wherein the plurality of skin portions change an overall length in the front-rear direction of the vehicle through a movement of at least one of the plurality of movable portions in the front-rear direction of the vehicle, and
the plurality of skin portions are maintained to overlap in a movable range of the plurality of movable portions.

2. The vehicle spoiler according to claim 1, wherein
at least a part of the plurality of movable portions is connected through an elastic body, and
the plurality of movable portions are driven by driving portions which are less in number than the plurality of movable portions.

3. The vehicle spoiler according to claim 1, wherein
each of the plurality of skin portions comprises a main body portion and a plurality of connecting portions extending from the main body portion to the front and the rear of the front-rear direction of the vehicle,
each of the plurality of skin portions is connected to an adjacent skin portion by making the plurality of connecting portions to pass through lower sides of the main body portions comprised in the skin portions adjacent to each other in the front-rear direction of the vehicle.

4. The vehicle spoiler according to claim 2, wherein
each of the plurality of skin portions comprises a main body portion and a plurality of connecting portions extending from the main body portion to the front and the rear of the front-rear direction of the vehicle,
each of the plurality of skin portions is connected to an adjacent skin portion by making a plurality of connecting portions to pass through lower sides of the main body portions comprised in the skin portions adjacent to each other in the front-rear direction of the vehicle.
